(19) United States
(12) Patent Application Publication
(10) Pub. No.: US 2011/0197587 A1
(43) Pub. Date: Aug. 18, 2011

(54) MULTI-TUBE PREMIXING INJECTOR

(75) Inventors: Baifang Zuo, Simpsonville, SC (US); Thomas Edward Johnson, Greer, SC (US); Benjamin Paul Lacy, Greer, SC (US); Ertan Yilmaz, Glenville, NY (US); Willy Steve Ziminsky, Greenville, SC (US)

(73) Assignee: GENERAL ELECTRIC COMPANY, Schenectady, NY (US)

(21) Appl. No.: 12/707,754

(22) Filed: Feb. 18, 2010

(51) Int. Cl. F02C 7/22

(52) U.S. Cl. 60/740; 239/398

(57) ABSTRACT

A fuel injection nozzle includes at least one tube disposed in the nozzle having a venturi shaped profile defining a gas flow path including an inlet operative to receive a first gas, at least one port operative to emit a second gas into the gas flow path, and an outlet operative to emit a mixture of the first gas and the second gas into a combustor.

### FEDERAL RESEARCH STATEMENT

This invention was made with Government support under Government Contract #DE-FC26-05NT42643 awarded by Department of Energy. The Government has certain rights in this invention.

### BACKGROUND OF THE INVENTION

The subject matter disclosed herein relates to fuel injectors for turbine engines.

Gas turbine engines may operate using a number of different types of fuels, including natural gas and other hydrocarbon fuels. Other fuels, such as, for example hydrogen (H₂) and mixtures of hydrogen and nitrogen may be burned in the gas turbine, and may offer reductions of emissions of carbon monoxide and carbon dioxide.

Hydrogen fuels often have a higher reactivity than natural gas fuels, causing hydrogen fuel to combust more easily. Thus, fuel nozzles designed for use with natural gas fuels may not be fully compatible for use with fuels having a higher reactivity. At the same time, fuel nozzles designed for high-reactivity fuels may not deliver low emissions levels for natural gas fuels.

### BRIEF DESCRIPTION OF THE INVENTION

According to one aspect of the invention, a fuel injection nozzle includes at least one tube disposed in the nozzle having a venturi shaped profile defining a gas flow path including an inlet operative to receive a first gas, at least one port operative to emit a second gas into the gas flow path, and an outlet operative to emit a mixture of the first gas and the second gas into a combustor.

According to another aspect of the invention, a fuel injection nozzle includes a housing member defining a first plenum operative to receive a first gas, a plurality of tubes connected to the housing member each tube having an inlet operative to receive a second gas, an outlet communicative with the inlet and a combustor, and at least one port communicative with the first plenum, and a faceplate portion comprising at least a first segment connected to a distal end of one tube of the plurality of tubes and at least a second segment connected to a distal end of a second tube of the plurality of tubes.

According to yet another aspect of the invention, fuel injection nozzle includes at least one tube disposed in the nozzle defining a gas flow path having an inlet operative to receive a first gas, at least one port operative to emit the second gas into the gas flow path, an outlet operative to emit a mixture of the first gas and the second gas into a combustor, an entry region having a constant diameter, a convergence region adjacent to the entry region having a decreasing diameter, and a third region adjacent to the convergence region having a constant diameter.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIGS. 1 and 2 illustrate perspective views of an exemplary embodiment of a multi-tube fuel nozzle.

FIG. 3 illustrates a perspective view of the fuel plenum member and mixing tubes of the fuel nozzle of FIG. 1.

FIGS. 4-6 illustrate a side, cross-sectional views of the fuel nozzle of FIG. 1.

FIG. 7 illustrates a front view of the nozzle of FIG. 1.

FIG. 8 illustrates a side, cross-sectional view of an alternate embodiment of the fuel nozzle of FIG. 1.

FIG. 9 illustrates a side, cross-sectional view of another alternate embodiment of the fuel nozzle of FIG. 1.

The detailed description explains embodiments of the invention, together with advantages and features, by way of example with reference to the drawings.

### DETAILED DESCRIPTION OF THE INVENTION

Gas turbine engines may operate using a variety of fuels. The use of natural gas (NG) and synthetic gas (Syngas), for example, offers savings in fuel cost and decreases carbon and other undesirable emissions. Some gas turbine engines inject the fuel into a combustor where the fuel mixes with an air stream and is ignited. One disadvantage of mixing the fuel and air in the combustor is that the mixture may not be uniformly mixed prior to combustion. The combustion of a non-uniform fuel air mixture may result in some portions of the mixture combusting at higher temperatures than other portions of the mixture. Locally-higher flame temperatures may drive higher emissions of undesirable pollutants such as NOx.

One method for overcoming the non-uniform fuel/air mixture in the combustor includes mixing the fuel and air prior to injecting the mixture into the combustor. The method is performed by, for example, a multi-tube fuel nozzle. The use of a multi-tube fuel nozzle to mix, for example, natural gas and air allows a uniform mixture of fuel and air to be injected into the combustor prior to ignition of the mixture. Hydrogen gas (H₂), Syngas, and mixtures of hydrogen and, for example, nitrogen gas used as fuel offer a further reduction in pollutants emitted from the gas turbine.

Hydrogen gas and Syngas, for example, have higher reactivity properties than natural gas. The higher reactivity properties of these fuels may cause an undesirable flame flashback effect where the fuel combusts in the fuel nozzle prior to reaching the combustor. The flashback of the flame may damage the fuel nozzle.

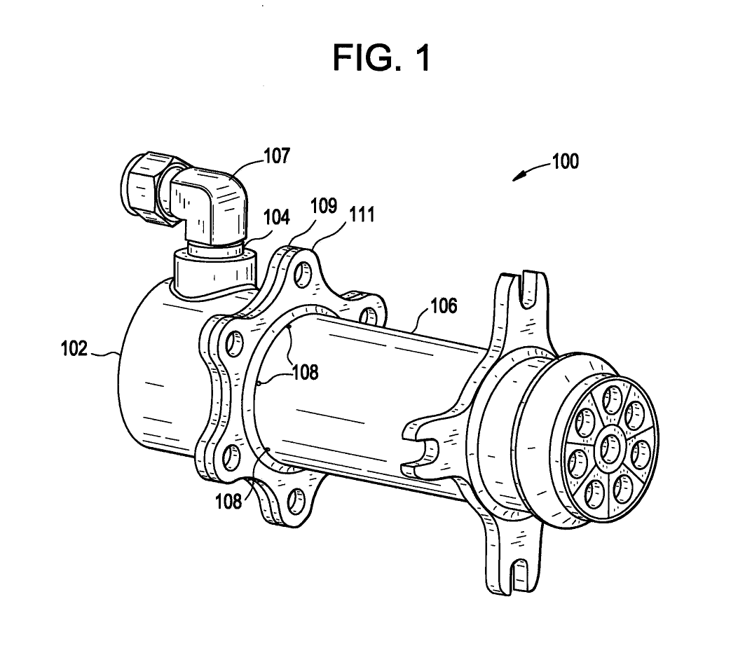

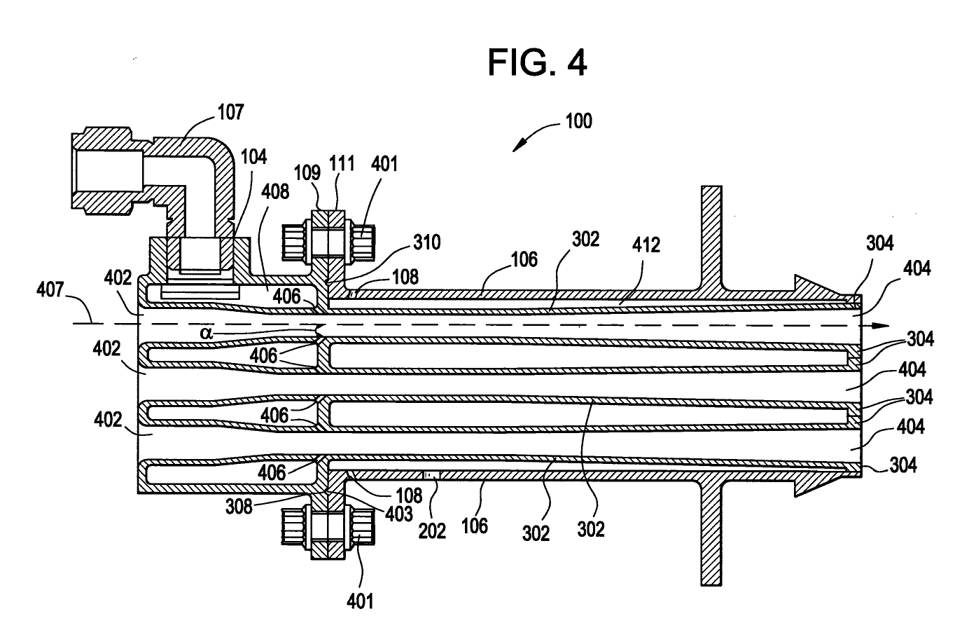

FIG. 1 illustrates a perspective view of an exemplary embodiment of a of a multi-tube fuel nozzle (injector) 100. The injector 100 includes a fuel plenum housing member (fuel plenum member) 102 having a fuel inlet portion 104 connected to a fuel line 107; and a tubular shroud portion 106 that engages the fuel plenum member 102. The shroud portion 106 may include a plurality of ports 108 that are operative to receive pressurized gas, such as, for example, compressed air. The fuel plenum member 102 and the shroud portion 106 may be secured together at flanges 109 and 111 using, for example, fasteners 401 (illustrated in FIG. 4).

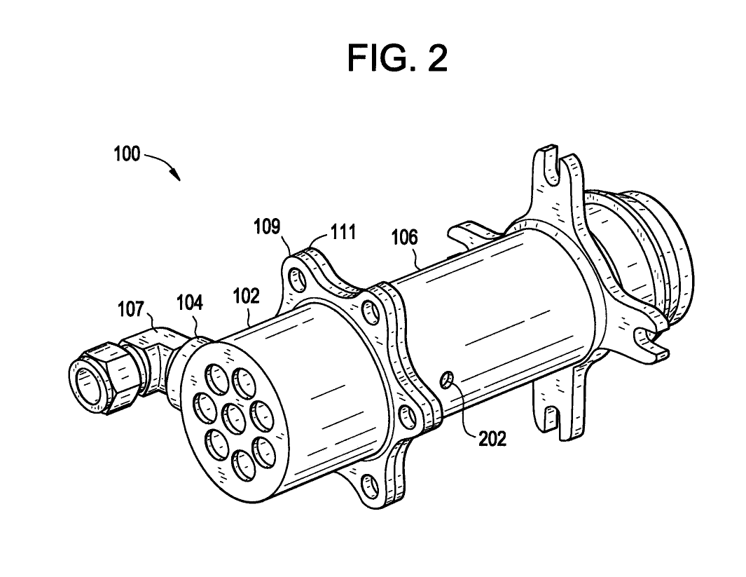

FIG. 2 illustrates another perspective view of the injector 100. The illustrated embodiment may include a port 202 in the shroud portion 106 that may be used to rout a connector for sensors (not shown) such as, for example, thermocouples that may be placed in the injector 100.

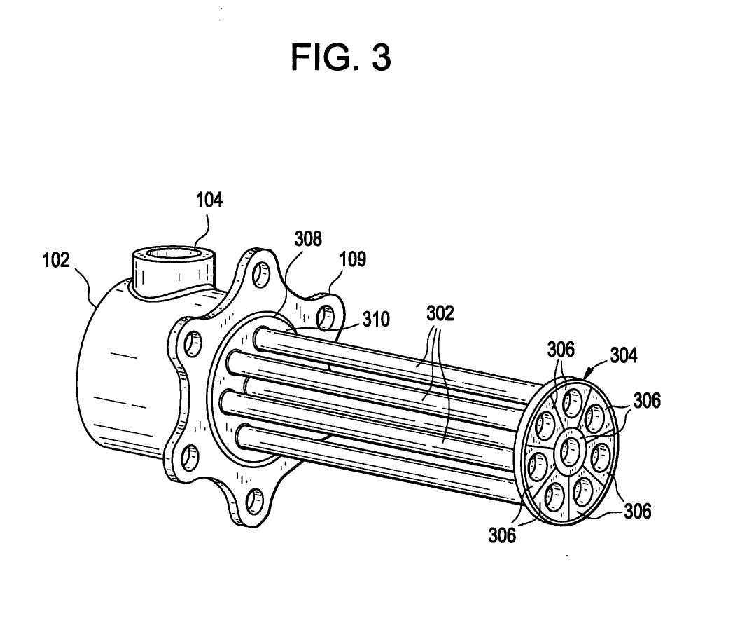

FIG. 3 illustrates a perspective view of the fuel plenum member 102 that is connected to a plurality of mixing tubes 302. The mixing tubes 302 are connected to the fuel plenum member 102 at a downstream wall 310 and extend distally to define a faceplate portion 304. The face plate portion 304 includes a plurality of separate faceplate segments 306. Each faceplate segment 306 is connected to a mixing tube 302. The fuel plenum member 102 may include a female channel 308 in the flange 109. The channel 308 may engage a corresponding raised male ridge 403 (illustrated in FIG. 4) that improves the alignment and seal between the fuel plenum member 102 and the shroud portion 106 (of FIG. 1).

FIG. 4 illustrates a side, cross-sectional view of the injector 100. The fuel plenum member 102 is connected to the shroud portion 106 with fasteners 401. The fuel plenum member 102 and the shroud portion 106 may be aligned and sealed with the channel 308 and the ridge 403. The mixing tubes 302 include tube inlets 402 and tube outlets 404. Each mixing tube 302 includes at least one port 406 that is communicative with a fuel plenum 408 defined by the fuel plenum member 102. In the illustrated embodiment, the ports 406 are aligned at an angle (α). The angle α is between 20 and 45 degrees relative to the longitudinal axis 407 of the mixing tube 302, however the angle α may be any angle including 90 degrees. The downstream wall 310 of the fuel plenum member 102 contacts the shroud portion 106. A shroud plenum 412 is defined by the downstream wall 310, the inner surface of the shroud portion 106 and the inner surface of the face plate portion 304. The ports 108 are communicative with the shroud plenum 412.

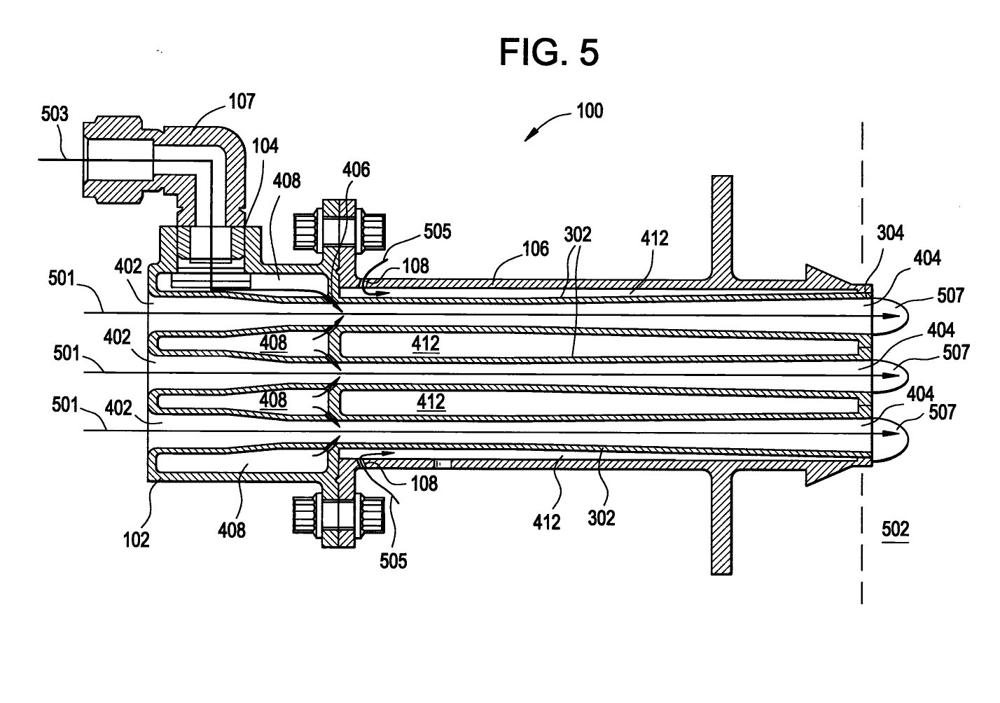

FIG. 5 illustrates an example of the operation of the injector 100. A side, cross-sectional view of the injector 100 similar to FIG. 4 is shown. In operation, a first gas 501 enters the mixing tubes 302 via the tube inlets 402. The first gas 501 may include, for example, air or a mixture of gasses including air and other gasses such as nitrogen or fuels. A second gas 503 enters the fuel plenum 408 via the fuel line 107 and the fuel inlet portion 104. The second gas 503 enters the mixing tubes 302 via the ports 406, and mixes with the first gas 501. The mixture of the first gas 501 and the second gas 503 is emitted into a combustor portion 502 of a turbine and combusts in flame regions 507. A third gas 505 such as, for example, compressed air, may enter the shroud plenum 412 via the ports 108. The third gas 505 cools the mixing tubes 302 and the shroud portion 106 and may be emitted from outlets in the face plate portion 304.

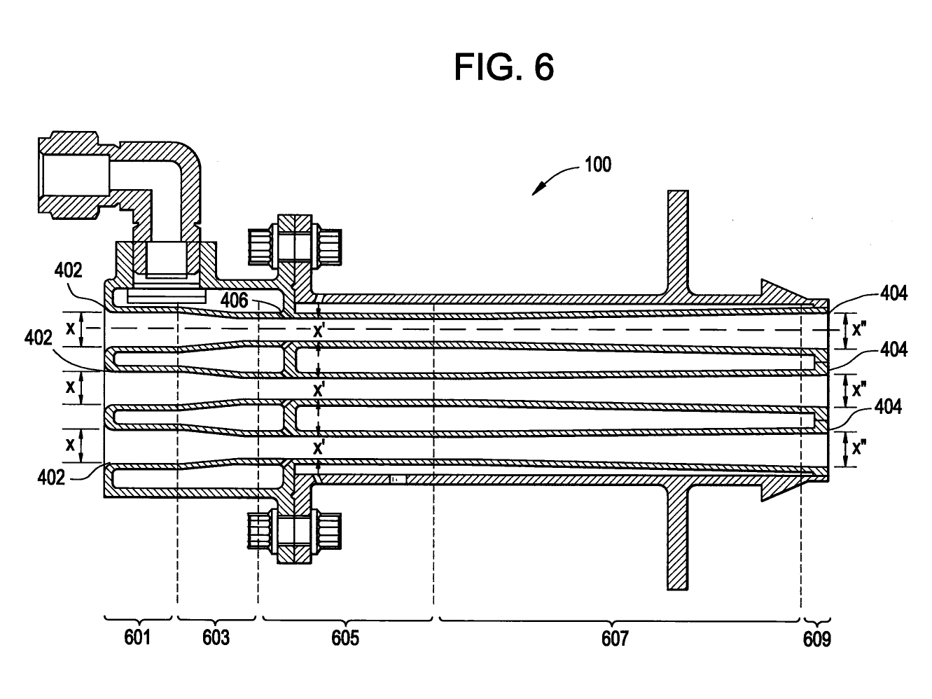

FIG. 6 is similar to FIGS. 4 and 5, and illustrates the venturi shaped profile of the mixing tubes 302. The venturi shaped profile of the mixing tubes 302 includes an entry portion 601 having a constant first diameter (x) at the tube inlets 402. The diameter of the mixing tubes 302 decreases in a convergence region 603 to a second diameter (x′). The mixing tubes 302 have a constant diameter in the region 605. The diameter of the mixing tubes 302 increases in a divergence region 607 to a third diameter (x″) in a region 609 at the tube outlets 404.

In operation, the venturi shaped profile of the mixing tubes 302 increases the velocity of the first gas 501 (of FIG. 5) as the diameter of the mixing tubes 302 decreases from x to x′. The ports 406 emit the second gas 503 (of FIG. 5) into the mixing tubes 302 in the vicinity of the second diameter x′. The first and second gases 501 and 503 mix in the mixing tubes 302 downstream from the ports 406. The increased velocity of the first gas 501 reduces the potential for flame-holding in the region when the second gas 503 enters and begins to mix with the gas flow of the first gas 501. The higher velocity flow of the first gas 501 in the entry region of the second gas 503 acts to reduce the possibility of the fuel combusting in the mixing tubes 302. The first gas 502 and the second gas 503 continue to mix in the constant diameter region 605. Maintaining constant diameter reduces downstream pressure losses. The mixing tubes 302 increase in diameter in the divergence region 607 to the third diameter x″ in the region 609 allowing the recovery of some dynamic pressure. The third diameter x″ at the tube outlets 404 may be similar to or equal to the first diameter x. The similarity of the first diameter x at the tube inlets 402 and the third diameter x″ at the tube outlets 404 decreases the exit velocity of the gas mixture and reduces the overall pressure loss in the mixing tubes 302.

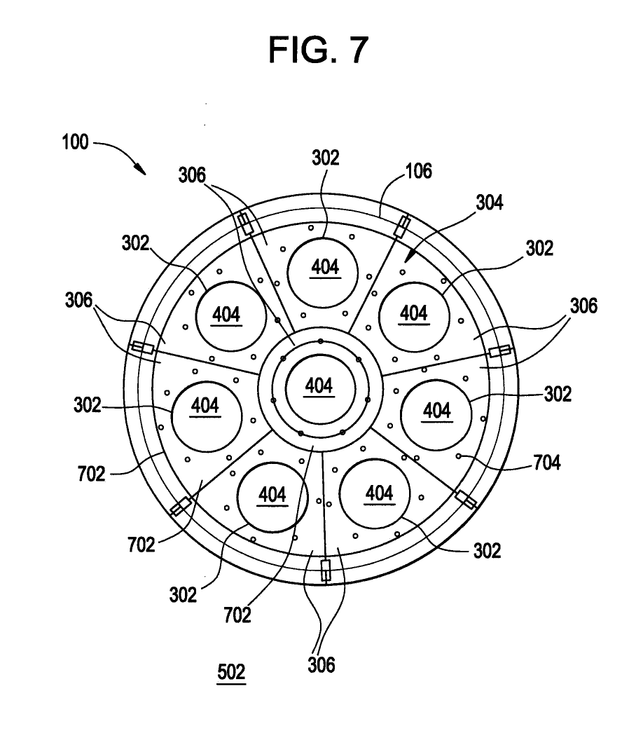

FIG. 7 illustrates a front view of the nozzle 100 including the face plate portion 304. Each mixing tube 302 is connected to a face plate segment 306. The face plate segments 306 are separated to define gaps 702 that are communicative with the shroud plenum 412 (of FIG. 4) and the combustor portion 502. In operation, the third gas 505 (of FIG. 5) cools the nozzle 100, and is emitted from the shroud plenum 412 into the combustor portion 502 via the gaps 702. The dimensions of the gaps 702 may be designed to meet cooling gas flow specifications for the nozzle 100. In some embodiments, the face plate segments 306 may include ports 704 that are communicative with the shroud plenum 412 and the combustor portion 502. The dimensions, location, and number of ports 704 may be varied to meet cooling gas flow specifications.

In operation, the each of the mixing tubes 302 and the shroud portion 106 are exposed to heat and may expand or contract at different rates due to thermal, geometric, and material variations in the nozzle 100. Since the face plate segments 306 and the shroud portion 106 are separated by the gaps 702, the face plate segments 306 may move relative to each other and the shroud portion 106 without imparting forces on adjacent components in the nozzle 100. For example, since each mixing tube 302 is connected to the downstream wall 310 of the fuel plenum member 102, but separated from the other mixing tubes 302 and the shroud portion 106 by the gaps 702 defined by the face plate segments 306, each mixing tube 302 may independently expand and contract linearly from the fuel plenum member 102.

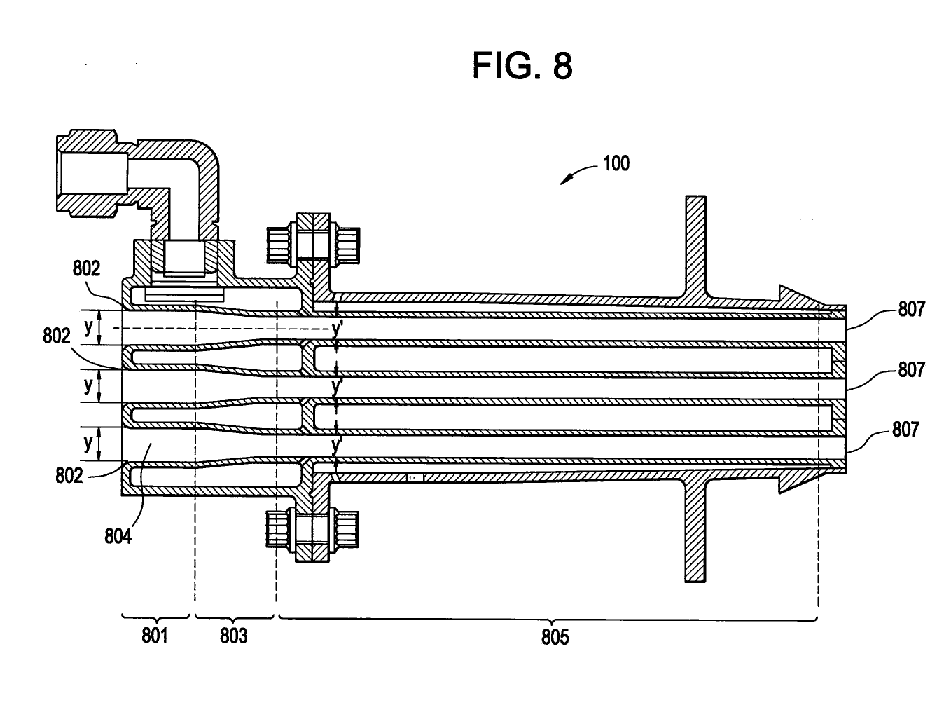

FIG. 8 illustrates a side, cross-sectional view of an exemplary alternate embodiment of the injector 100. The illustrated embodiment includes mixing tubes 802 having a venturi shaped profile that includes an entry portion 801 having a constant first diameter (y) at the tube inlets 804. The diameter of the mixing tubes 802 decreases in a convergence region 803 to a second diameter (y′). The mixing tubes 802 have a constant diameter y′ in the region 805 and at the tube outlets 807.

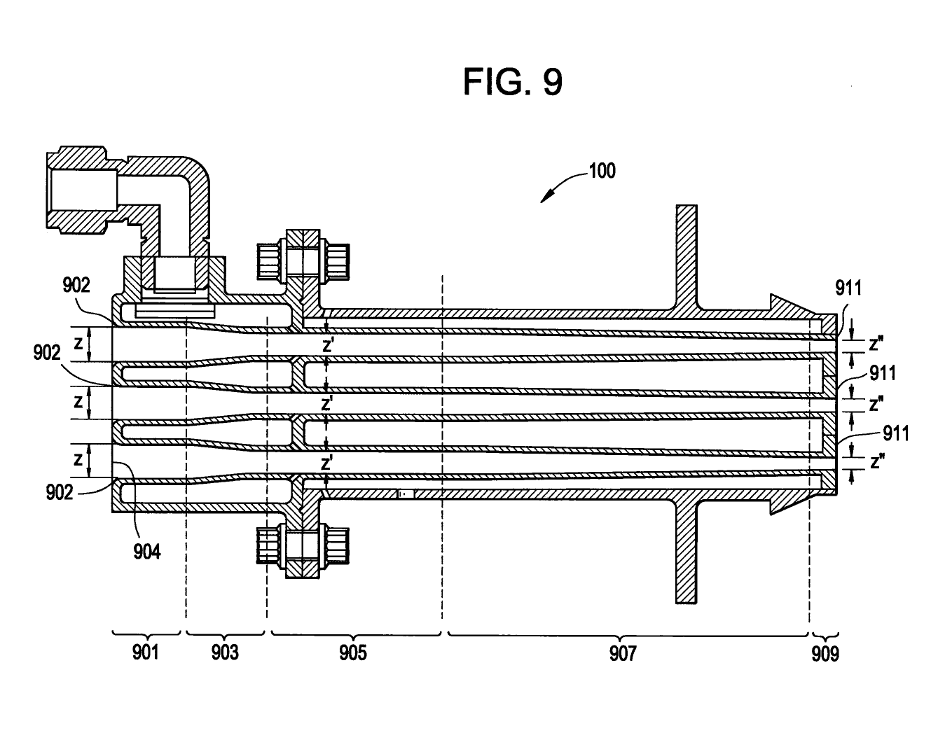

FIG. 9 illustrates a side, cross-sectional view of another exemplary alternate embodiment of the injector 100. The illustrated embodiment includes mixing tubes 902 having a venturi shaped profile that includes an entry portion 801 having a constant first diameter (z) at the tube inlets 904. The diameter of the mixing tubes 902 decreases in a convergence region 903 to a second diameter (z′). The mixing tubes 902 have a constant diameter in the region 905. The diameter of the mixing tubes 904 decreases in a second convergence region 907 to a third diameter (z″) in a region 909 at the tube outlets 911. In operation, the velocity flow of the gas flow path increases in the second convergence region 907.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A fuel injection nozzle including:
at least one tube disposed in the nozzle having a venturi shaped profile defining a gas flow path including:
an inlet operative to receive a first gas;
at least one port operative to emit a second gas into the gas flow path; and
an outlet operative to emit a mixture of the first gas and the second gas into a combustor.

2. The nozzle of claim 1, wherein the venturi shaped profile of the at least one tube includes:
an entry region having a constant diameter;
a convergence region adjacent to the entry region having a decreasing diameter;
a third region adjacent to the convergence region having a constant diameter; and
a divergence region adjacent to the third region having an increasing diameter.

3. The nozzle of claim 2, wherein the venturi shaped profile of the at least one tube includes a fourth region adjacent to the divergence region having a constant diameter.

4. The nozzle of claim 2, wherein the diameter of the entry region is greater than the diameter of the third region.

5. The nozzle of claim 3, wherein the diameter of the fourth region is greater than the diameter of the third region.

6. The nozzle of claim 3, wherein the diameter of the entry region is equal to the diameter of the fourth region.

7. The nozzle of claim 1, wherein the venturi shaped profile of the tube includes:
an entry region having a constant diameter; and
a convergence region adjacent to the entry region having a decreasing diameter.

8. The nozzle of claim 7, wherein the venturi shaped profile of the tube includes a third region having a constant diameter.

9. The nozzle of claim 7, wherein the venturi shaped profile of the tube includes a third region having a decreasing diameter.

10. The nozzle of claim 1, wherein the nozzle further includes a shroud portion that partially defines a second plenum around the tube.

11. The nozzle of claim 10, wherein the second plenum is operative to receive a third gas that is operative to cool the tube.

12. The nozzle of claim 1, wherein the nozzle further includes a first faceplate segment connected to a distal end of the tube and a second faceplate segment connected to a distal end of a second tube, the first faceplate segment and the second faceplate segment define a gap between the first faceplate segment and the second faceplate segment.

13. A fuel injection nozzle including:
a housing member defining a first plenum operative to receive a first gas;
a plurality of tubes connected to the housing member, each tube having an inlet operative to receive a second gas, an outlet communicative with the inlet and a combustor, and at least one port communicative with the first plenum, the port operative to emit the first gas into at least one of the plurality of tubes; and
a faceplate portion comprising at least a first segment connected to a distal end of one tube of the plurality of tubes and at least a second segment connected to a distal end of a second tube of the plurality of tubes.

14. The nozzle of claim 13, wherein the at least one first segment and the at least one second segment define a gap between the at least one first segment and the at least one second segment.

15. The nozzle of claim 13, wherein the nozzle further includes a shroud portion connected to the housing member that partially defines a second plenum.

16. The nozzle of claim 15, wherein the second plenum is operative to receive a third gas and is communicative with a gap between the at least one first segment and the at least one second segment.

17. The nozzle of claim 13, wherein at least one tube of the plurality of tubes has a venturi shaped profile.

18. The nozzle of claim 15, wherein the faceplate portion includes at least one port communicative with the second plenum and the combustor.

19. A fuel injection nozzle including at least one tube disposed in the nozzle defining a gas flow path including:
an inlet operative to receive a first gas;
at least one port operative to emit the second gas into the gas flow path;
an outlet operative to emit a mixture of the first gas and the second gas into a combustor;
an entry region having a constant diameter;
a convergence region adjacent to the entry region having a decreasing diameter; and
a third region adjacent to the convergence region having a constant diameter.

20. The fuel injection nozzle of claim 19, wherein the nozzle includes a faceplate portion comprising at least a first segment connected to a distal end of the at least one tube, the faceplate portion defining a gap between the faceplate portion and a shroud portion.
